(19) United States
(12) Patent Application Publication
(10) Pub. No.: US 2025/0192719 A1
(43) Pub. Date: Jun. 12, 2025

(54) Semi-automatic portable solar controller

(71) Applicant: Yongyang Qiu, Chino Hills, CA (US)

(72) Inventor: Yongyang Qiu, Chino Hills, CA (US)

(21) Appl. No.: 18/531,757

(22) Filed: Dec. 7, 2023

(51) Int. Cl. H02S 30/20

(52) U.S. Cl. CPC H02S 30/20

(57) ABSTRACT

This utility model relates to the field of solar energy technology and provides a semi-automatic portable solar controller. It includes a support rod with a stabilizing mechanism at one end and a fastening mechanism at the other end. The other end of the support rod is movably fitted with a connecting rod. In this utility model, by rotating the movable rod to a certain angle and then rotating the limit rod to a certain angle, and allowing one end of the limit rod to be wedged in the limit block position, the angle of upward rotation of the movable rod is limited. At this time, by rotating the upper inner threaded ring, it can pass through the action of the threaded connection with the outer threaded sleeve, thereby keeping the outer threaded sleeve and the connecting rod relatively fixed. This can prevent the solar folding soft panel from being blown away in windy weather, ensuring the normal use of the solar folding soft panel, and also making it convenient to disassemble and install the entire device, making it easy to use and suitable for outdoor travel.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Technical Field

The present utility model relates to the field of solar energy technology, particularly to a semi-automatic portable solar controller.

### Background Technology

Solar energy is generated by the release of enormous nuclear energy from the fusion of hydrogen atoms inside the sun. The energy from the sun, mainly in the form of sunlight, is commonly used for generating electricity or providing energy for water heaters. The utilization of solar energy includes thermal conversion and photovoltaic conversion. Solar power generation is a renewable energy source with the characteristics of being renewable, abundant, and universal.

In existing technology, portable solar panels have become essential for outdoor travel, meeting the power needs of users during outdoor activities. However, when using portable solar panels, users usually lay them flat on the ground or use simple supports, making the panels vulnerable to being blown away by the wind. This not only affects the effectiveness of the solar panels but also prevents adjusting the angle of the panels, resulting in the panels being unable to maintain a perpendicular angle for extended periods of time. As a result, the efficiency of solar energy conversion to electricity is reduced.

### SUMMARY

The purpose of the present utility model is to solve the problems in the existing technology, where portable solar panels have become essential for outdoor travel as they meet the users' electricity needs. However, when using portable solar panels, users usually lay them flat on the ground or support them with simple stands. This makes the solar panels prone to being blown away by the wind, affecting their effectiveness. Additionally, it is difficult to adjust the angle of the solar panels, resulting in an inability to maintain a perpendicular angle to the sunlight for an extended period, leading to low efficiency in converting solar energy into electricity.

The purpose of this utility model is to address the aforementioned issues in existing technology. It provides a semi-automatic portable solar controller that can be used during outdoor travel, ensuring the effectiveness of the solar panels and allowing for adjustable angles to maximize solar energy conversion efficiency.

To achieve the above objectives, the following technical solution is adopted: a semi-automatic portable solar controller comprising a support rod. One end of the support rod is equipped with a stabilizing mechanism, while the other end is fitted with a fastening mechanism. The other end of the support rod is movably fitted with a connecting rod. Two adjustment mechanisms are located above the support rod, and above each adjustment mechanism is a foldable solar panel. The stabilizing mechanism consists of two triangular blocks, with the inner walls of the triangular blocks fixedly fitted onto one end of the support rod. Furthermore, it includes multiple U-shaped blocks fixedly installed on the three sides of the two triangular blocks. The opposing sides of the arms of multiple U-shaped blocks are movably fitted with limit rods. Additionally, movable rods are also movably fitted on the opposing sides of the arms of multiple U-shaped blocks. Multiple limit blocks are equally spaced and fixedly installed at the top of multiple movable rods. One end of multiple limit rods is movably fitted inside each of the limit blocks. One side of multiple movable rods is fixedly installed with insertion rods. The battery box is fixedly installed at one end of the support rod.

The preferred embodiment includes a fixed block one, which is fixedly fitted on the outer surface of the connecting rod near one end. One side of the fixed block one is equipped with a slot one, and the other side has a threaded screw one. The outer surface of the connecting rod near the center is movably fitted with a hollow square rod one, and the inside of the hollow square rod one is movably fitted with a sliding rod one. The top end of the sliding rod one is fixedly installed with a fixed block two, which has a slot two on one side and a threaded screw four on the other side. The outer surface of the hollow square rod one near one end is threaded with screw two, and the outer surface of the connecting rod near the center is threaded with screw three.

The preferred embodiment further includes two adjustment mechanisms, which consist of multiple folding rods and two locking blocks. The outer surfaces of the two locking blocks are movably fitted inside slot one and slot two, respectively. One side of each locking block is fixedly installed with a hollow square rod two. The inside of each hollow square rod two is symmetrically movably fitted with two sliding rods two. One end of multiple folding rods is movably fitted with a round rod one, and one end of each round rod one is fixedly installed with a vertical rod. The bottom of each vertical rod is fixedly installed at the two ends of the top of the two hollow square rods two and one end of multiple sliding rods two.

Furthermore, the other end of multiple folding rods is movably fitted with a round rod two. The outer surface of each folding rod near the other end is threaded with an inner threaded ring two, and the other end of each folding rod is fixedly installed with multiple clips two arranged in a circular array.

The preferred embodiment includes hinges fixedly installed at one end of multiple round rods two and one end of multiple vertical rods. The hinges are evenly divided into multiple groups, and one side of each group of hinges is fixedly installed with elastic bands with Velcro two. Both sides of the two solar folding panels are symmetrically fixedly installed with two elastic bands with Velcro one. Multiple elastic bands with Velcro one are adhered to multiple elastic bands with Velcro two.

The preferred embodiment further includes a fastening mechanism, which consists of an outer threaded sleeve. The inner wall of the outer threaded sleeve is movably fitted on one end of the support rod. Both ends of the outer threaded sleeve are fixedly installed with multiple clips one arranged in a circular array. The outer surface of the outer threaded sleeve is threaded with two inner threaded rings one.

The preferred embodiment further includes a rechargeable battery installed inside the battery box, and a solar sensor is fixedly installed at one end of the connecting rod.

The preferred embodiment uses elastic plastic material for multiple clips one and multiple clips two.

Compared to the prior art, the advantages and positive effects of this utility model are:
1. By rotating the movable rod to a certain angle and then rotating the limit rod to a certain angle, and positioning one end of the limit rod at the position of the limit block, the upward rotation angle of the movable rod is limited. With the cooperation of the inserted rod, the support rod can be stably fixed. Then, insert the connecting rod above the support rod. At this time, by rotating the inner threaded ring one above, it can move upward through the action of the threaded connection with the outer threaded sleeve, which can bring the clips one closer to the middle and tightly adhere to the outer surface of the connecting rod. This ensures that the outer threaded sleeve and the connecting rod are relatively fixed. Similarly, by rotating the lower clips one, the outer threaded sleeve can be kept relatively fixed with the support rod. With the weight of the rechargeable battery inside the battery box and the influence of the solar folding panels on both sides, the entire device can be more stable. This prevents the solar folding panels from being blown away in windy weather, ensuring their normal use. It also facilitates the disassembly and installation of the entire device, making it convenient to use, suitable for outdoor travel.

The utility model adjusts the tilt angle of the solar folding panels by moving the round rod two up or down a certain distance and sliding it outward or inward with the cooperation of the hinge. By manually rotating the inner threaded ring two, it can move upward along the outer surface of the folding rod, bringing the clips two closer to the middle and tightly adhering to the round rod two, maintaining a relatively fixed state between the folding rod and the round rod two. By coordinating with the lower inner threaded ring one, the relative fixed state between the support rod and the outer threaded sleeve can be temporarily released, allowing the rotation of the outer threaded sleeve and the connecting rod, thus adjusting the orientation of the solar folding panels. This allows the solar folding panels to be adjusted to a direction with sufficient sunlight, thereby improving the efficiency of converting solar energy into electrical energy.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a front view of the structure of a semi-automatic portable solar controller provided by this utility model;

FIG. 2 is a rear view of the structure of a semi-automatic portable solar controller provided by this utility model;

FIG. 3 is a schematic diagram of the structure of the solar folding panels provided by this utility model;

FIG. 4 is a schematic diagram of the adjustment mechanism structure of the semi-automatic portable solar controller provided by this utility model;

FIG. 5 is a schematic diagram of the stability mechanism structure of the semi-automatic portable solar controller provided by this utility model.

### LEGEND

1. Support rod; 101. Connecting rod; 102. Battery box; 103. Solar sensor;
2. Fastening mechanism; 201. Outer threaded sleeve; 202. Clip one; 203. Inner threaded ring one;
3. Stability mechanism; 301. Triangle block; 302. U-shaped block; 303. Limiting rod; 304. Movable rod; 305. Limiting block; 306. Inserted rod;
4. Fixing block one; 401. Screw one; 402. Slot one; 403. Hollow square rod one; 404. Sliding rod one; 405. Screw two; 406. Screw three; 407. Fixing block two; 408. Screw four; 409. Slot two;
5. Adjustment mechanism; 501. Card block; 502. Hollow square rod two; 503. Sliding rod two; 504. Vertical rod; 505. Hinge; 506. Round rod one; 507. Folding rod; 508. Round rod two; 509. Inner threaded ring two; 510. Clip two; 511. Elastic band with Velcro one; 512. Elastic band with Velcro two;
6. Solar folding panels.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

In order to better understand the purpose, features, and advantages of this utility model, the following description is provided in conjunction with the drawings and embodiments. It should be noted that, unless conflicting, the features of the embodiments described in this application can be combined with each other.

The following description provides many specific details to fully understand this utility model. However, this utility model can also be implemented in ways different from those described here. Therefore, this utility model is not limited to the specific embodiments described in this specification.

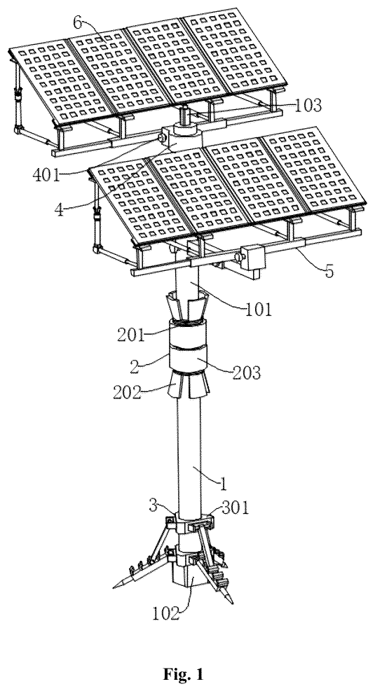

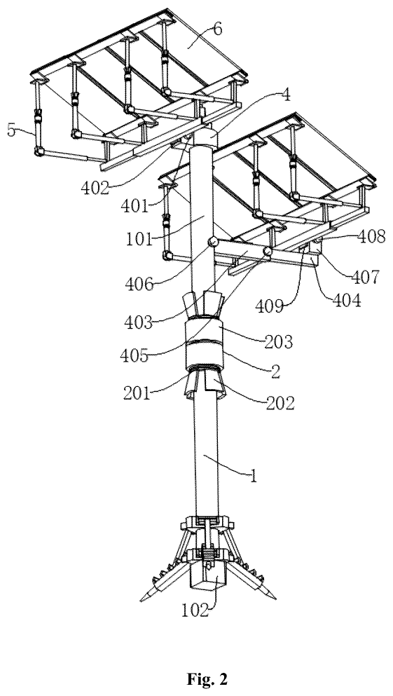

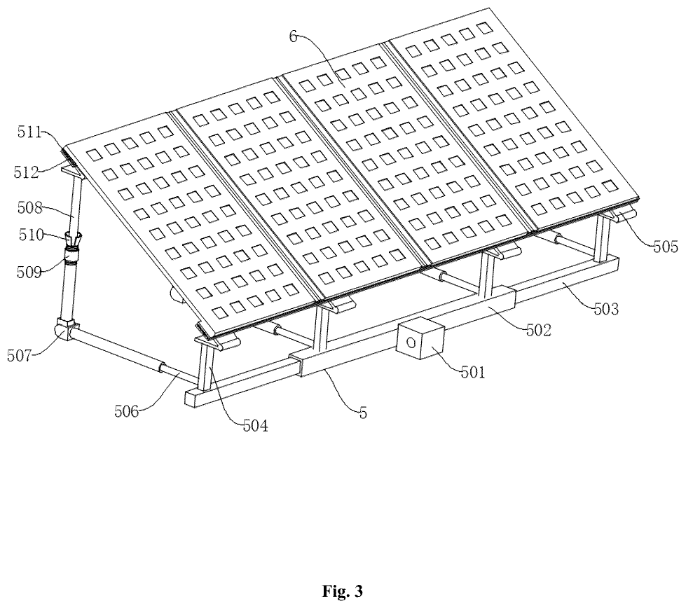

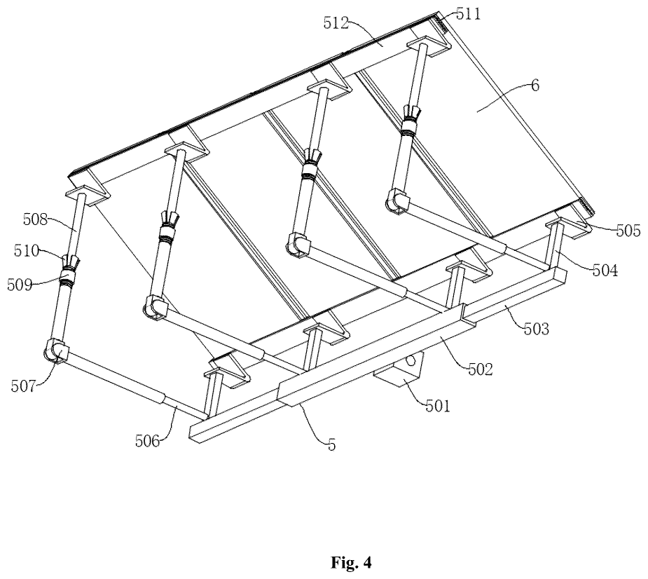

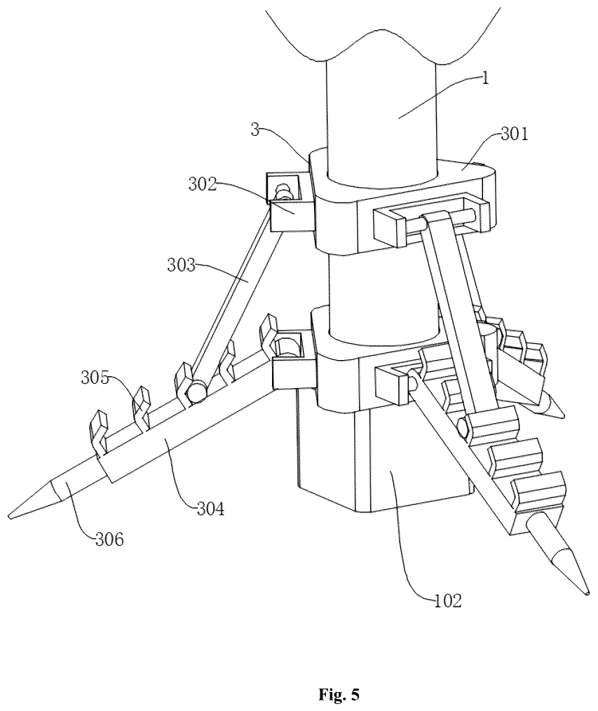

Embodiment 1, as shown in FIGS. 1-5, this utility model provides a semi-automatic portable solar controller, comprising: a support rod 1, one end of which is equipped with a stability mechanism 3, and the other end of which is equipped with a fastening mechanism 2. The other end of the support rod 1 is movably fitted with a connecting rod 101. Two adjustment mechanisms 5 are located above the support rod 1. Solar folding panels 6 are installed above the two adjustment mechanisms 5. The stability mechanism 3 includes two triangular blocks 301, the inner walls of which are fixedly fitted on one end of the support rod 1. It also includes multiple U-shaped blocks 302, which are respectively fixedly installed on the three sides of the two triangular blocks 301. The two arms of each U-shaped block 302 on one side are movably fitted with limiting rods 303. Additionally, the two arms of each U-shaped block 302 on one side are movably fitted with movable rods 304. Multiple limiting blocks 305 are equidistantly fixedly installed on the top of the movable rods 304. One end of multiple limiting rods 303 is movably fitted inside the multiple limiting blocks 305. One side of each movable rod 304 is fixedly fitted with inserted rods 306. One end of the support rod 1 is fixedly installed with a battery box 102. The outer surface of the connecting rod 101 near one end is fitted with a fixing block 1 4. One side of the fixing block 1 4 has a slot 1 402, and one side of the fixing block 1 4 has a screw 1 401. The outer surface of the connecting rod 101 near the center is movably fitted with a hollow square rod 1 403. The inner part of the hollow square rod 1 403 is movably fitted with a sliding rod 1 404. One end of the sliding rod 1 404 is fixedly installed with a fixing block 2 407. One side of the fixing block 2 407 has a slot 2 409, and one side of the fixing block 2 407 has a screw 4 408. The outer surface of the hollow square rod 1 403 near one end has a screw 2 405. The outer surface of the connecting rod 101 near the center has a screw 3 406. The fastening mechanism 2 includes an outer threaded sleeve 201, the inner wall of which is movably fitted on one end of the support rod 1. The outer surface of the outer threaded sleeve 201 is threaded and fitted with multiple clips 1 202 arranged in a circular array. The outer surface of the outer threaded sleeve 201 is threaded and fitted with two inner threaded rings 1 203. The interior of the battery box 102 is equipped with a battery, and one end of the connecting rod 101 is fixedly installed with a solar sensor 103.

In this embodiment, by rotating the movable rod 304 to a certain angle and then rotating the limiting rod 303 to a certain angle, and placing one end of the limiting rod 303 at the position of the limiting block 305, the upward rotation angle of the movable rod 304 is limited. With the cooperation of the inserted rod 306, the support rod 1 can be stably fixed. Then, insert the connecting rod 101 above the support rod 1. At this time, by rotating the inner threaded ring 1 203 above, it can move upward through the thread engagement with the outer threaded sleeve 201, bringing the clips 1 202 closer to the center and tightly adhering to the outer surface of the connecting rod 101. This ensures that the outer threaded sleeve 201 and the connecting rod 101 are in a relatively fixed state. Similarly, by rotating the lower clips 1 202, the outer threaded sleeve 201 can be kept in a relatively fixed state with the support rod 1, and with the weight of the battery inside the battery box 102, and the positioning effect provided by the two solar folding panels 6, the entire device can be relatively stable. This can prevent the solar folding panels 6 from being blown away during windy weather, ensuring their normal use, and facilitating the disassembly and installation of the entire device. It is convenient to use and suitable for outdoor travel.

Embodiment 2, as shown in FIGS. 1-5, the two adjustment mechanisms 5 include multiple folding rods 507 and two locking blocks 501. The outer surfaces of the two locking blocks 501 are respectively movably fitted inside the slots 1 402 and 2 409. One side of each locking block 501 is fixedly installed with a hollow square rod 2 502. The inner part of each hollow square rod 2 502 is symmetrically movably fitted with two sliding rods 2 503. One end of multiple folding rods 507 is movably fitted with round rods 1 506. One end of multiple round rods 1 506 is fixedly installed with vertical rods 504. The bottom of multiple vertical rods 504 is fixedly installed on the top ends of the two hollow square rods 2 502 and one end of multiple sliding rods 2 503. The other end of multiple folding rods 507 is movably fitted with round rods 2 508. The outer surface of the folding rods 507 near the other end is threaded and fitted with inner threaded rings 2 509 arranged in a circular array. Multiple clips 2 510 are fixedly installed in a circular array on the other end of multiple folding rods 507. One end of multiple round rods 2 508 and one end of multiple vertical rods 504 are fixedly installed with hinges 505. The hinges 505 are divided into multiple groups, and one side of each group of hinges 505 is fixedly installed with elastic bands with Velcro 2 512. Two sides of the two solar folding panels 6 are symmetrically fixedly installed with two elastic bands with Velcro 1 511. Multiple elastic bands with Velcro 1 511 are respectively connected and bonded with multiple elastic bands with Velcro 2 512. The clips 1 202 and clips 2 510 are made of elastic plastic material.

In this particular implementation, there is a mechanism that allows for the adjustment of the tilt angle of the solar folding panel. By moving the round rod up or down and coordinating with the hinge, the round rod can slide towards the outer or inner side of the folding rod. This movement adjusts the tilt angle of the solar folding panel. Additionally, by manually rotating the inner threaded ring along the outer surface of the folding rod, the clamp can be brought closer to the center and tightly fit with the round rod, ensuring a relatively fixed state between the folding rod and the round rod.

Furthermore, by coordinating with the inner threaded ring below, the support rod and the outer threaded sleeve can be temporarily released from their fixed state. This allows for the rotation of the outer threaded sleeve and the connecting rod, which enables the adjustment of the orientation of the solar folding panel. By positioning the panel in a direction where it receives sufficient sunlight, the efficiency of converting solar energy into electricity can be improved.

The working principle of this mechanism is as follows:

First, rotate the movable rod 304 by a certain angle, and then rotate the limit rod 303 by a certain angle, ensuring that one end of the limit rod 303 is wedged in the position of the limit block 305. This limits the upward rotation angle of the movable rod 304. With the insertion of the plug rod 306, the support rod 1 can be stably fixed. Next, insert the connecting rod 101 above the support rod 1. By rotating the upper inner threaded ring 203, it can move upward through the threading with the outer threaded sleeve 201. This brings the clamp 202 closer to the center and tightly fits with the outer surface of the connecting rod 101, ensuring a relatively fixed state between the outer threaded sleeve 201 and the connecting rod 101. Similarly, by rotating the lower clamp 202, the outer threaded sleeve 201 can be kept in a relatively fixed state with the support rod 1.

Then, with the action of the screw 406, the hollow square rod 403 can be fixed above the connecting rod 101. In conjunction with the screw 405, the length of the sliding rod 404 extending from the inside of the hollow square rod 403 can be adjusted, while maintaining a relatively fixed state between the hollow square rod 403 and the sliding rod 404. Next, insert the two clamps 501 into the internal slots 402 and 409, and tighten the screws 401 and 408 to secure the clamps 501. This completes the limitation of the clamps 501. At this point, the sliding rod 503 can be pulled out from the inside of the hollow square rod 502, while maintaining a relatively fixed state between the hollow square rod 502 and the sliding rod 503.

Then, unfold the folding rod 507 and lock its shape. Next, unfold the solar folding panel 6 and attach the Velcro strap 511 to the Velcro strap 512, completing the installation of the solar folding panel 6. Adjust the tilt angle of the solar folding panel 6 according to the direction of sunlight. By moving the round rod 508 up or down a certain distance and coordinating with the hinge 505, the round rod 506 can slide towards the outer or inner side of the folding rod 507. This allows for the adjustment of the tilt angle of the solar folding panel 6. By manually rotating the inner threaded ring 509 along the outer surface of the folding rod 507, it can move upward and bring the clamp 510 closer to the center, tightly fitting with the round rod 508. This ensures a relatively fixed state between the folding rod 507 and the round rod 508.

Lastly, with the coordination of the lower inner threaded ring 203, the support rod 1 and the outer threaded sleeve 201 can be temporarily released from their fixed state. This allows for the rotation of the outer threaded sleeve 201 and the connecting rod 101, enabling the adjustment of the orientation of the solar folding panel 6. This adjustment ensures that the solar folding panel 6 is positioned in a direction where it receives sufficient sunlight, thereby improving the efficiency of converting solar energy into electricity.

The above description is only the preferred embodiment of the present utility model and is not intended to limit the utility model to any other form. Any person skilled in the art may make changes or modifications based on the disclosed technical content to achieve equivalent embodiments in other fields. However, any simple modifications, equivalent changes, or variations made to the above embodiments, which do not depart from the technical essence of the utility model, are still within the scope of protection of the utility model.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A semi-automatic portable solar controller comprising;
a support rod (1), wherein one end of the support rod (1) is equipped with a stabilizing mechanism (3), and the other end of the support rod (1) is equipped with a fastening mechanism (2);
An adjustable mechanism (5) is provided above the support rod (1), and a solar folding soft panel (6) is provided above each adjustable mechanism (5);
The stabilizing mechanism (3) includes two triangular blocks (301), and the inner walls of the two triangular blocks (301) are fixedly fitted to one end of the support rod (1);
Multiple U-shaped blocks (302), each of which is fixedly installed on the three sides of the two triangular blocks (301);
On one side of the two arms of each U-shaped block (302), there are movably fitted limit rods (303), On the opposite side of the two arms of each U-shaped block (302), there are movably fitted movable rods (304);
Multiple limit blocks (305) are equally and fixedly installed at the top of multiple movable rods (304), One end of multiple limit rods (303) is movably fitted inside multiple limit blocks (305), One side of multiple movable rods (304) is fixedly installed with insertion rods (306), One end of the support rod (1) is fixedly installed with a battery box (102).

2. In the described semi-automatic portable solar controller according to claim 1, the connecting rod (101) is fixedly fitted with a fixing block 1 (4) on the outer surface near one end of the connecting rod (101);
One side of the fixing block 1 (4) is provided with a slot 1 (402), and one side of the fixing block 1 (4) is threaded with a screw 1 (401);
The outer surface of the connecting rod (101) near the center is movably fitted with a hollow square rod 1 (403), and the inside of the hollow square rod 1 (403) is movably fitted with a sliding rod 1 (404);
One end of the sliding rod 1 (404) at the top is fixedly installed with a fixing block 2 (407), and one side of the fixing block 2 (407) is provided with a slot 2 (409), One side of the fixing block 2 (407) is threaded with a screw 4 (408);
The outer surface of the hollow square rod 1 (403) near one end is threaded with a screw 2 (405), and the outer surface of the connecting rod (101) near the center is threaded with a screw 3 (406).

3. In the described semi-automatic portable solar controller according to claim 1, two adjustable mechanisms (5) comprise multiple folding rods (507) and two locking blocks (501);
The outer surfaces of the two locking blocks (501) are movably fitted inside the slots 1 (402) and 2 (409) respectively. One side of each of the two locking blocks (501) is fixedly installed with a hollow square rod 2 (502);
The inside of each of the two hollow square rods 2 (502) is symmetrically fitted with two sliding rods 2 (503). One end of each folding rod (507) is movably fitted with a round rod 1 (506), and one end of each round rod 1 (506) is fixedly installed with a vertical rod (504);
The bottoms of multiple vertical rods (504) are fixedly installed at the two ends of the top of the two hollow square rods 2 (502) and one end of multiple sliding rods 2 (503).

4. In the described semi-automatic portable solar controller according to claim 3, the other end of multiple folding rods (507) is movably fitted with a round rod 2 (508), the outer surfaces of the multiple folding rods (507) near the other end are threaded with internal threaded rings 2 (509), Multiple clamps 2 (510) are fixedly installed in a circular array at the other end of multiple folding rods (507).

5. In the described semi-automatic portable solar controller according to claim 4, one end of multiple round rods 2 (508) and one end of multiple vertical rods (504) are fixedly installed with hinges (505);
The hinges (505) are divided into multiple groups, and one side of each group of hinges (505) is fixedly installed with elastic bands with Velcro 2 (512);
Both sides of the two solar folding soft panels (6) are symmetrically fixedly installed with two elastic bands with Velcro 1 (511), and multiple elastic bands with Velcro 1 (511) are adhered to multiple elastic bands with Velcro 2 (512).

6. A semi-automatic portable solar controller according to claim 3, characterized in that the fastening mechanism (2) comprises an external threaded sleeve (201), and the inner wall of the external threaded sleeve (201) is movably fitted onto one end of the support rod (1) the two ends of the external threaded sleeve (201) are fixedly installed with multiple clamp pieces 1 (202) in a circular array, and the outer surface of the external threaded sleeve (201) is threaded with two internal threaded rings 1 (203).

7. A semi-automatic portable solar controller according to claim 2, characterized in that the interior of the battery box (102) is equipped with a battery, and one end of the connecting rod (101) is fixedly installed with a solar sensor (103).

8. A semi-automatic portable solar controller according to claim 6, characterized in that the multiple clamp pieces 1 (202) and multiple clamp pieces 2 (510) are made of elastic plastic material.
